(19) United States
(12) Patent Application Publication
(10) Pub. No.: US 2023/0177810 A1
(43) Pub. Date: Jun. 8, 2023

(54) PERFORMING SEMANTIC SEGMENTATION TRAINING WITH IMAGE/TEXT PAIRS

(71) Applicant: NVIDIA Corporation, Santa Clara, CA (US)

(72) Inventors: Jiarui Xu, San Diego, CA (US); Shalini De Mello, San Francisco, CA (US); Sifei Liu, San Diego, CA (US); Wonmin Byeon, Santa Cruz, CA (US); Thomas Breuel, Sunnyvale, CA (US); Jan Kautz, Lexington, MA (US)

(21) Appl. No.: 17/853,631

(22) Filed: Jun. 29, 2022

Related U.S. Application Data
(60) Provisional application No. 63/287,440, filed on Dec. 8, 2021.

(51) Int. Cl. G06V 10/774; G06V 10/26

(52) U.S. Cl. CPC G06V 10/774; G06V 10/26

(57) ABSTRACT

Semantic segmentation includes the task of providing pixel-wise annotations for a provided image. To train a machine learning environment to perform semantic segmentation, image/caption pairs are retrieved from one or more databases. These image/caption pairs each include an image and associated textual caption. The image portion of each image/caption pair is passed to an image encoder of the machine learning environment that outputs potential pixel groupings (e.g., potential segments of pixels) within each image, while nouns are extracted from the caption portion and are converted to text prompts which are then passed to a text encoder that outputs a corresponding text representation. Contrastive loss operations are then performed on features extracted from these pixel groupings and text representations to determine an extracted feature for each noun of each caption that most closely matches the extracted features for the associated image.

### CLAIM OF PRIORITY

This application claims the benefit of U.S. Provisional Application No. 63/287,440 (Attorney Docket No. NVIDP1344+/21-SC-2160US01) titled “SEMANTIC SEGMENTATION WITH IMAGE-TEXT PAIRS,” filed Dec. 8, 2021, the entire contents of which is incorporated herein by reference.

### FIELD OF THE INVENTION

The present invention relates to machine learning, and more particularly to preparing training data to train a machine learning environment to perform image analysis.

### BACKGROUND

Semantic segmentation includes the task of providing pixel-wise annotations for a provided image. For example, performing semantic segmentation on an input image results in an association of each pixel within the input image with an associated entity. Machine learning solutions are used to perform semantic segmentation, but there are limitations currently associated with these implementations. For example, training such machine learning solutions requires the labor and resource-intensive manual creation of training datasets with pixel-level annotations, and current machine learning solutions are limited to training categories only and do not work well with new unseen classes.

There is therefore a need to address these and other problems associated with training machine learning solutions to perform semantic segmentation.

### BRIEF DESCRIPTION OF THE DRAWINGS

FIG. 1 illustrates a flowchart of a method for performing semantic segmentation training with image/text pairs, in accordance with an embodiment.

FIG. 2 illustrates a parallel processing unit, in accordance with an embodiment.

FIG. 3A illustrates a general processing cluster within the parallel processing unit of FIG. 2, in accordance with an embodiment.

FIG. 3B illustrates a memory partition unit of the parallel processing unit of FIG. 2, in accordance with an embodiment.

FIG. 4A illustrates the streaming multi-processor of FIG. 3A, in accordance with an embodiment.

FIG. 4B is a conceptual diagram of a processing system implemented using the PPU of FIG. 2, in accordance with an embodiment.

FIG. 4C illustrates an exemplary system in which the various architecture and/or functionality of the various previous embodiments may be implemented.

FIG. 5 illustrates an exemplary machine learning environment for performing semantic segmentation, in accordance with an embodiment.

FIG. 6 illustrates an exemplary GroupViT Architecture and Training Pipeline for performing semantic segmentation, according to one exemplary embodiment.

### DETAILED DESCRIPTION

Semantic segmentation includes the task of providing pixel-wise annotations for a provided image. To train a machine learning environment to perform semantic segmentation, image/caption pairs are retrieved from one or more databases. These image/caption pairs each include an image and associated textual caption. The image portion of each image/caption pair is passed to an image encoder of the machine learning environment that outputs potential pixel groupings (e.g., potential segments of pixels) within each image, while nouns are extracted from the caption portion and are converted to text prompts along with the original caption are then passed to a text encoder that outputs corresponding text representations for them. Contrastive loss operations are then performed on features extracted from these pixel groupings and text representations to determine an extracted feature for each noun of each caption and the caption itself that most closely matches the extracted features for the associated image.

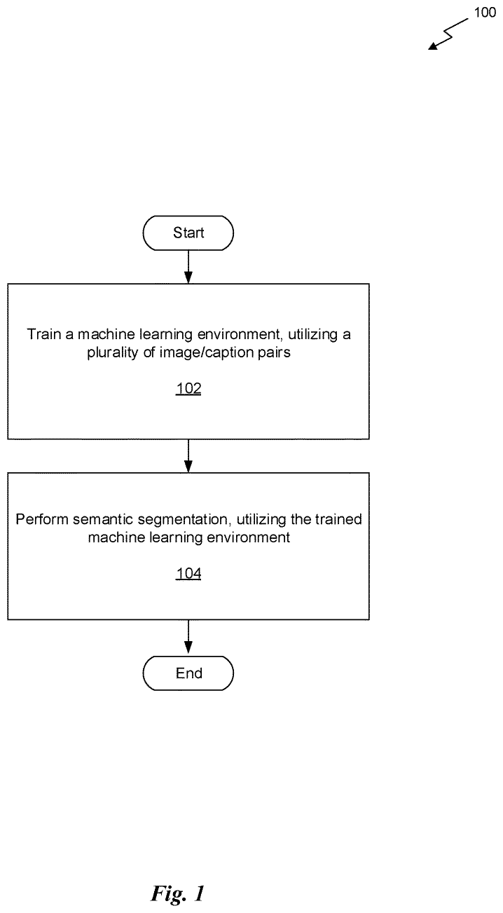

FIG. 1 illustrates a flowchart of a method 100 for performing semantic segmentation training with image/text pairs, in accordance with an embodiment. Although method 100 is described in the context of a processing unit, the method 100 may also be performed by a program, custom circuitry, or by a combination of custom circuitry and a program. For example, the method 100 may be executed by a GPU (graphics processing unit), CPU (central processing unit), or any processing element. Furthermore, persons of ordinary skill in the art will understand that any system that performs method 100 is within the scope and spirit of embodiments of the present invention.

As shown in operation 102, a machine learning environment is trained utilizing a plurality of image/caption pairs. In one embodiment, the machine learning environment may include one or more neural networks, one or more encoders, etc. In another embodiment, the machine learning environment may be trained to perform semantic segmentation. For example, the performance of semantic segmentation may include the determination of an annotation for each pixel within an input image.

Additionally, in one embodiment, the plurality of image/caption pairs used to train the machine learning environment may be retrieved from one or more image databases (e.g., one or more internet repositories, etc.). For example, each of the plurality of image/caption pairs may include a generally available stock image with a corresponding caption describing the image. In another embodiment, the plurality of image/caption pairs used to train the machine learning environment may be retrieved in response to a query (e.g., an internet search query, etc.).

Further, in one embodiment, the machine learning environment may include an image encoder. For example, the image encoder may utilize a transformer architecture. In another example, the image encoder may include a vision transformer (ViT). In another embodiment, for each of the plurality of image/caption pairs, the image may be extracted and input into the image encoder.

For example, the image encoder may output potential pixel groupings (e.g., potential segments of pixels within the image). In another example, each of the potential groupings may indicate the potential presence of an entity within the image. For instance, the entity may include an object, an animal, a human, a building, etc.

In yet another example, the image encoder may divide the image into a grid (e.g., a set of non-overlapping spatial regions/image tokens/patches, etc.). The image encoder may include a transformer architecture that computes a large similarity matrix between all pairs of image tokens. The image encoder may also include a plurality of learnable group tokens that are randomly initialized and included with the image tokens. These tokens may be passed through transformer layers, and the results may be passed to a grouping block which identifies each image token and determines to which group token the image token is most similar.

The grouping block may then make a hard assignment between each image token and a single group token. Representations may be averaged for all image tokens assigned to the same group token, which may result in segment tokens. These segment tokens are then passed through a second group of transformer layers and a second grouping block. This may perform a bottom-up, hierarchical spatial grouping of semantic concepts (starting at the pixel level), where multi-stage hierarchical groupings are used to assign image tokens to successively smaller subsets of learnable group tokens to refine such groupings. This may result in semantically grouped potential image segments for the image.

Further still, in one embodiment, the machine learning environment may include a text encoder. For example, the text encoder may include a neural network separate from the image encoder. In another embodiment, for each of the plurality of image/caption pairs, the caption may be extracted and input into the text encoder. For example, the caption may include text describing the associated image. In another example, one or more nouns may be extracted from the caption.

In yet another example, each extracted noun may be converted to a text prompt. For instance, the text prompt may provide context to the noun by embedding the noun in a sentence. For example, if the noun is “dog,” the text prompt may include the sentence “This is a picture of a dog.”

Also, in one embodiment, each text prompt may be input into the text encoder. For example, the text encoder may output a text representation of each input text prompt for each extracted noun.

In addition, in one embodiment, the machine learning environment may perform one or more contrastive loss operations during training. In another embodiment, for each of the plurality of image/caption pairs, the potential pixel groupings determined for the image may be converted to extracted features for the image (e.g., utilizing a multilayer perceptron (MLP), etc.). In another embodiment, for each of the plurality of image/caption pairs, the text representation of each input text prompt for each extracted noun determined for the caption may be converted to extracted features for nouns of the caption (e.g., utilizing a multilayer perceptron (MLP), etc.).

Furthermore, in one embodiment, the one or more contrastive loss operations may create a similarity matrix, utilizing the extracted features for the image and the extracted features for the nouns of the associated caption and the entire caption for the image. In another embodiment, additional similarity matrices may be created for the image and extracted features for other non-matching captions and their nouns. In yet another embodiment, for each of the extracted features for the image, the contrastive loss operations may compare similarity matrices to determine the extracted features for nouns of the caption and for the caption itself that most closely matches the extracted features for the image (when compared to extracted features for nouns and captions of other non-matching captions).

In this way, for each potential pixel grouping within the image, the contrastive loss operations of the machine learning environment may be trained to identify a noun from the caption that most closely matches the grouping.

Further still, as shown in operation 104, semantic segmentation is performed utilizing the trained machine learning environment. In one embodiment, an unlabeled image may be input into the trained machine learning environment. For example, the unlabeled image may include an image without any associated metadata, captions, etc.

Also, in one embodiment, the image encoder of the trained machine learning environment may output potential pixel groupings (e.g., potential segments of pixels) within the unlabeled image. For example, each of the potential groupings may indicate the potential presence of an entity within the unlabeled image.

Additionally, in one embodiment, a list of user-provided category names may also be input into the trained machine learning environment. For example, the category names may be created by a user based on a predetermined environment (e.g., an environment predicted to be associated with the unlabeled image, etc.). In another embodiment, each category name may be converted to a text prompt. For example, the text prompt may provide context to the category name by embedding the category name in a sentence. In yet another embodiment, each text prompt may be input into the text encoder. For example, the text encoder may output a text representation of each input text prompt for each category name.

Further, in one embodiment, the trained machine learning environment may perform one or more vision-text similarity computation operations during inference. For example, the inference may include the implementation of the trained machine learning environment. In another embodiment, the potential pixel groupings determined for the unlabeled image may be converted to extracted features for the unlabeled image (e.g., utilizing a multilayer perceptron (MLP), etc.). In yet another embodiment, the text representation of each input text prompt for each category name may be converted to extracted features for the category name (e.g., utilizing a multilayer perceptron (MLP), etc.).

Further still, in one embodiment, the one or more vision-text similarity computation operations may create a similarity matrix, utilizing the extracted features for the unlabeled image and the extracted features for the category names. In another embodiment, for each of the extracted features for the unlabeled image, the vision-text similarity computation operations may determine and return an extracted feature for a category name that most closely matches the extracted features for the unlabeled image.

In this way, for each potential pixel grouping within the unlabeled image, the vision-text similarity computation operations may be used to identify a category name that most closely matches the grouping. This may enable the efficient and effective training of a machine learning environment that performs semantic segmentation, utilizing generic and widely available image/caption pairs (as opposed to manually annotated training images). This may also completely avoid the use of pre-existing segmentation masks/labels during training of the machine learning environment, and may also allow for the dynamic identification of new categories for pixel groupings during training.

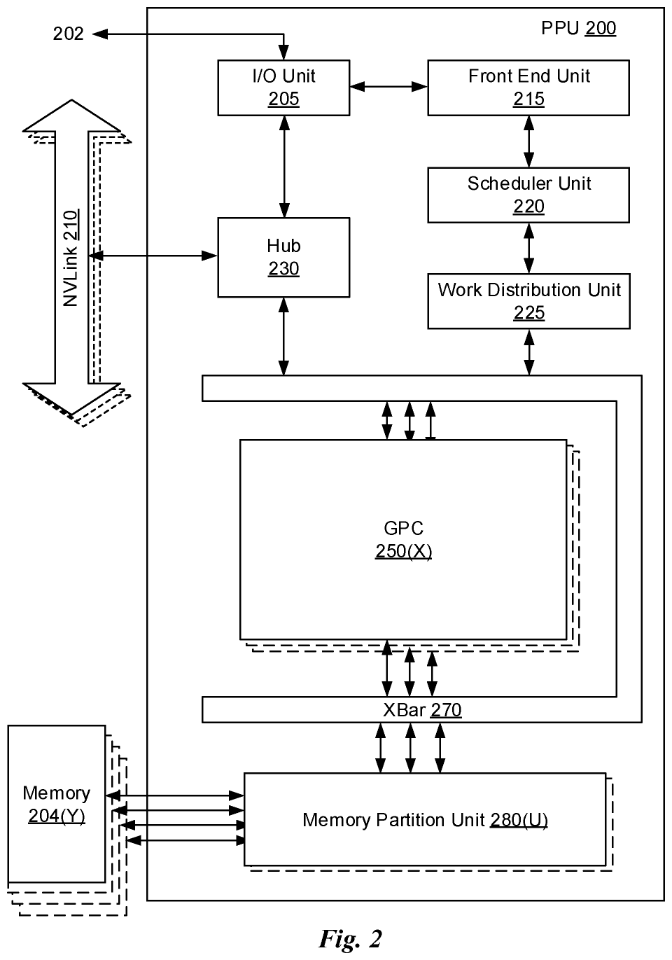

In yet another embodiment, the above functionality may be performed utilizing a parallel processing unit (PPU) such as the PPU 200 illustrated in FIG. 2.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

### Parallel Processing Architecture

FIG. 2 illustrates a parallel processing unit (PPU) 200, in accordance with an embodiment. In an embodiment, the PPU 200 is a multi-threaded processor that is implemented on one or more integrated circuit devices. The PPU 200 is a latency hiding architecture designed to process many threads in parallel. A thread (i.e., a thread of execution) is an instantiation of a set of instructions configured to be executed by the PPU 200. In an embodiment, the PPU 200 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the PPU 200 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 200 may be configured to accelerate thousands of High Performance Computing (HPC), data center, and machine learning applications. The PPU 200 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 2, the PPU 200 includes an Input/Output (I/O) unit 205, a front end unit 215, a scheduler unit 220, a work distribution unit 225, a hub 230, a crossbar (Xbar) 270, one or more general processing clusters (GPCs) 250, and one or more partition units 280. The PPU 200 may be connected to a host processor or other PPUs 200 via one or more high-speed NVLink 210 interconnect. The PPU 200 may be connected to a host processor or other peripheral devices via an interconnect 202. The PPU 200 may also be connected to a local memory comprising a number of memory devices 204. In an embodiment, the local memory may comprise a number of dynamic random access memory (DRAM) devices. The DRAM devices may be configured as a high-bandwidth memory (HBM) subsystem, with multiple DRAM dies stacked within each device.

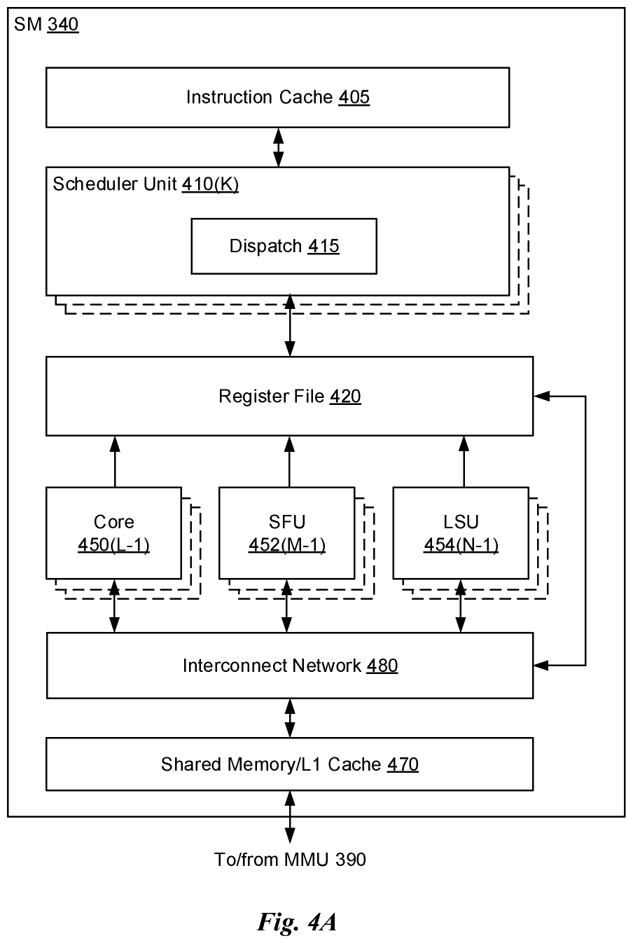

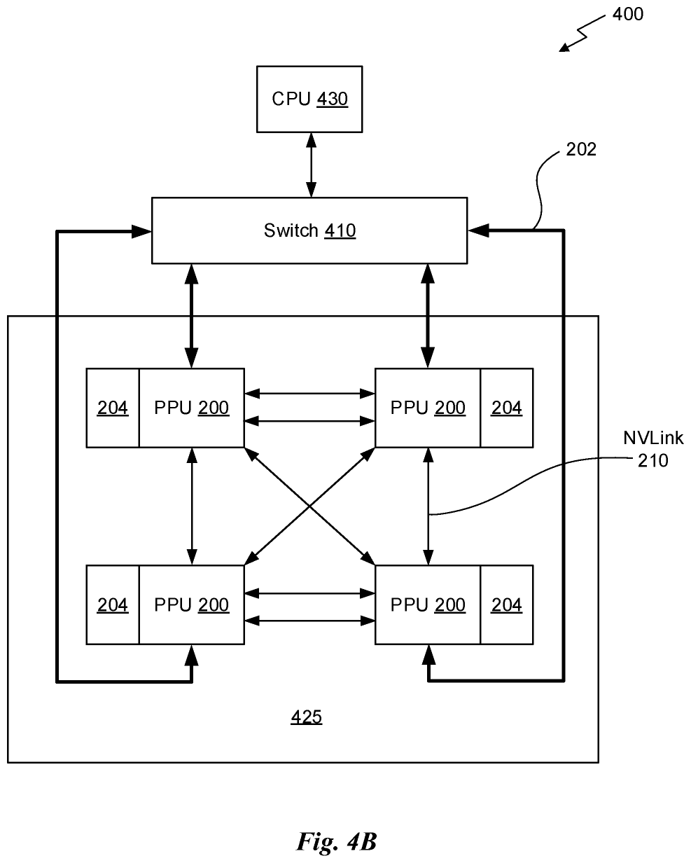

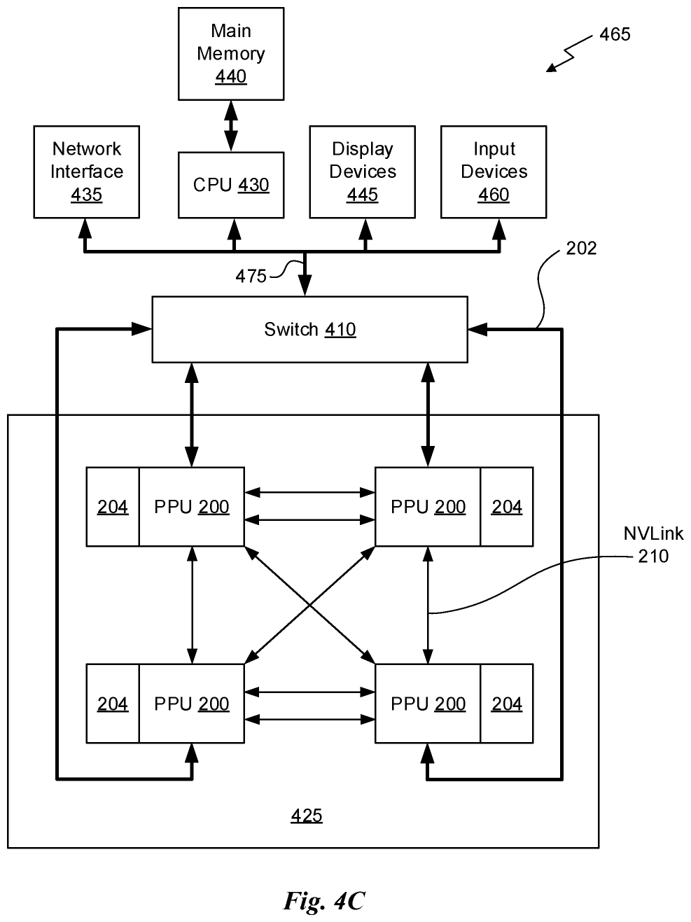

The NVLink 210 interconnect enables systems to scale and include one or more PPUs 200 combined with one or more CPUs, supports cache coherence between the PPUs 200 and CPUs, and CPU mastering. Data and/or commands may be transmitted by the NVLink 210 through the hub 230 to/from other units of the PPU 200 such as one or more copy engines, a video encoder, a video decoder, a power management unit, etc. (not explicitly shown). The NVLink 210 is described in more detail in conjunction with FIG. 4B.

The I/O unit 205 is configured to transmit and receive communications (i.e., commands, data, etc.) from a host processor (not shown) over the interconnect 202. The I/O unit 205 may communicate with the host processor directly via the interconnect 202 or through one or more intermediate devices such as a memory bridge. In an embodiment, the I/O unit 205 may communicate with one or more other processors, such as one or more the PPUs 200 via the interconnect 202. In an embodiment, the I/O unit 205 implements a Peripheral Component Interconnect Express (PCIe) interface for communications over a PCIe bus and the interconnect 202 is a PCIe bus. In alternative embodiments, the I/O unit 205 may implement other types of well-known interfaces for communicating with external devices.

The I/O unit 205 decodes packets received via the interconnect 202. In an embodiment, the packets represent commands configured to cause the PPU 200 to perform various operations. The I/O unit 205 transmits the decoded commands to various other units of the PPU 200 as the commands may specify. For example, some commands may be transmitted to the front end unit 215. Other commands may be transmitted to the hub 230 or other units of the PPU 200 such as one or more copy engines, a video encoder, a video decoder, a power management unit, etc. (not explicitly shown). In other words, the I/O unit 205 is configured to route communications between and among the various logical units of the PPU 200.

In an embodiment, a program executed by the host processor encodes a command stream in a buffer that provides workloads to the PPU 200 for processing. A workload may comprise several instructions and data to be processed by those instructions. The buffer is a region in a memory that is accessible (i.e., read/write) by both the host processor and the PPU 200. For example, the I/O unit 205 may be configured to access the buffer in a system memory connected to the interconnect 202 via memory requests transmitted over the interconnect 202. In an embodiment, the host processor writes the command stream to the buffer and then transmits a pointer to the start of the command stream to the PPU 200. The front end unit 215 receives pointers to one or more command streams. The front end unit 215 manages the one or more streams, reading commands from the streams and forwarding commands to the various units of the PPU 200.

The front end unit 215 is coupled to a scheduler unit 220 that configures the various GPCs 250 to process tasks defined by the one or more streams. The scheduler unit 220 is configured to track state information related to the various tasks managed by the scheduler unit 220. The state may indicate which GPC 250 a task is assigned to, whether the task is active or inactive, a priority level associated with the task, and so forth. The scheduler unit 220 manages the execution of a plurality of tasks on the one or more GPCs 250.

The scheduler unit 220 is coupled to a work distribution unit 225 that is configured to dispatch tasks for execution on the GPCs 250. The work distribution unit 225 may track a number of scheduled tasks received from the scheduler unit 220. In an embodiment, the work distribution unit 225 manages a pending task pool and an active task pool for each of the GPCs 250. The pending task pool may comprise a number of slots (e.g., 32 slots) that contain tasks assigned to be processed by a particular GPC 250. The active task pool may comprise a number of slots (e.g., 4 slots) for tasks that are actively being processed by the GPCs 250. As a GPC 250 finishes the execution of a task, that task is evicted from the active task pool for the GPC 250 and one of the other tasks from the pending task pool is selected and scheduled for execution on the GPC 250. If an active task has been idle on the GPC 250, such as while waiting for a data dependency to be resolved, then the active task may be evicted from the GPC 250 and returned to the pending task pool while another task in the pending task pool is selected and scheduled for execution on the GPC 250.

The work distribution unit 225 communicates with the one or more GPCs 250 via XBar 270. The XBar 270 is an interconnect network that couples many of the units of the PPU 200 to other units of the PPU 200. For example, the XBar 270 may be configured to couple the work distribution unit 225 to a particular GPC 250. Although not shown explicitly, one or more other units of the PPU 200 may also be connected to the XBar 270 via the hub 230.

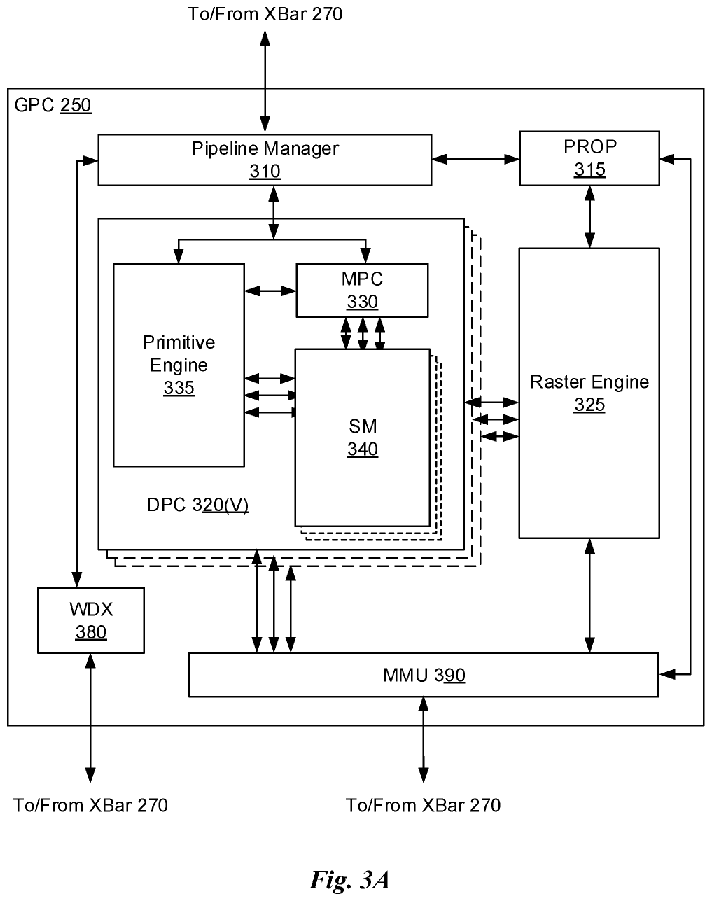

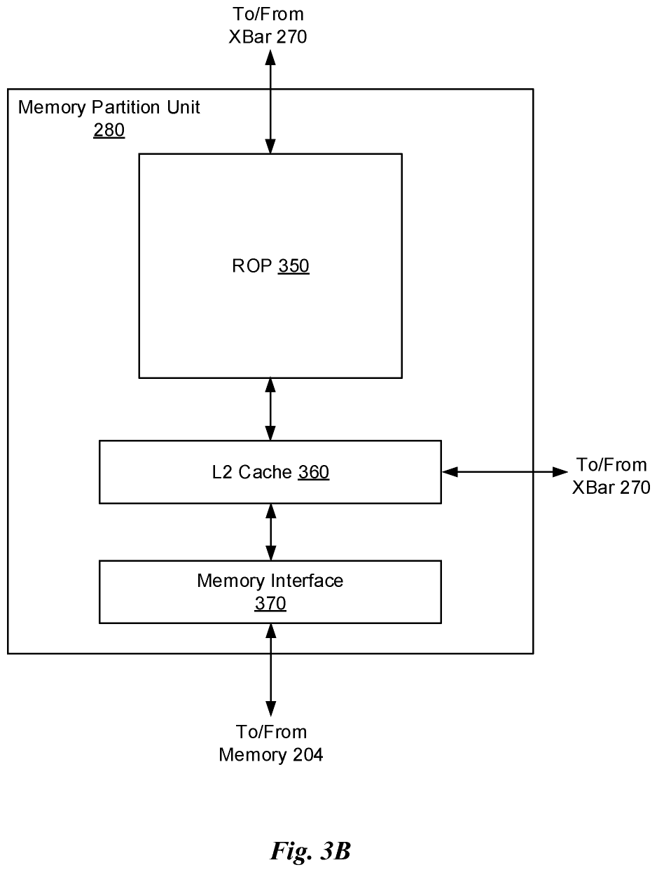

The tasks are managed by the scheduler unit 220 and dispatched to a GPC 250 by the work distribution unit 225. The GPC 250 is configured to process the task and generate results. The results may be consumed by other tasks within the GPC 250, routed to a different GPC 250 via the XBar 270, or stored in the memory 204. The results can be written to the memory 204 via the partition units 280, which implement a memory interface for reading and writing data to/from the memory 204. The results can be transmitted to another PPU 200 or CPU via the NVLink 210. In an embodiment, the PPU 200 includes a number U of partition units 280 that is equal to the number of separate and distinct memory devices 204 coupled to the PPU 200. A partition unit 280 will be described in more detail below in conjunction with FIG. 3B.

In an embodiment, a host processor executes a driver kernel that implements an application programming interface (API) that enables one or more applications executing on the host processor to schedule operations for execution on the PPU 200. In an embodiment, multiple compute applications are simultaneously executed by the PPU 200 and the PPU 200 provides isolation, quality of service (QoS), and independent address spaces for the multiple compute applications. An application may generate instructions (i.e., API calls) that cause the driver kernel to generate one or more tasks for execution by the PPU 200. The driver kernel outputs tasks to one or more streams being processed by the PPU 200. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 4A.

FIG. 3A illustrates a GPC 250 of the PPU 200 of FIG. 2, in accordance with an embodiment. As shown in FIG. 3A, each GPC 250 includes a number of hardware units for processing tasks. In an embodiment, each GPC 250 includes a pipeline manager 310, a pre-raster operations unit (PROP) 315, a raster engine 325, a work distribution crossbar (WDX) 380, a memory management unit (MMU) 390, and one or more Data Processing Clusters (DPCs) 320. It will be appreciated that the GPC 250 of FIG. 3A may include other hardware units in lieu of or in addition to the units shown in FIG. 3A.

In an embodiment, the operation of the GPC 250 is controlled by the pipeline manager 310. The pipeline manager 310 manages the configuration of the one or more DPCs 320 for processing tasks allocated to the GPC 250. In an embodiment, the pipeline manager 310 may configure at least one of the one or more DPCs 320 to implement at least a portion of a graphics rendering pipeline. For example, a DPC 320 may be configured to execute a vertex shader program on the programmable streaming multiprocessor (SM) 340. The pipeline manager 310 may also be configured to route packets received from the work distribution unit 225 to the appropriate logical units within the GPC 250. For example, some packets may be routed to fixed function hardware units in the PROP 315 and/or raster engine 325 while other packets may be routed to the DPCs 320 for processing by the primitive engine 335 or the SM 340. In an embodiment, the pipeline manager 310 may configure at least one of the one or more DPCs 320 to implement a neural network model and/or a computing pipeline.

The PROP unit 315 is configured to route data generated by the raster engine 325 and the DPCs 320 to a Raster Operations (ROP) unit, described in more detail in conjunction with FIG. 3B. The PROP unit 315 may also be configured to perform optimizations for color blending, organize pixel data, perform address translations, and the like.

The raster engine 325 includes a number of fixed function hardware units configured to perform various raster operations. In an embodiment, the raster engine 325 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x,y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 325 comprises fragments to be processed, for example, by a fragment shader implemented within a DPC 320.

Each DPC 320 included in the GPC 250 includes an M-Pipe Controller (MPC) 330, a primitive engine 335, and one or more SMs 340. The MPC 330 controls the operation of the DPC 320, routing packets received from the pipeline manager 310 to the appropriate units in the DPC 320. For example, packets associated with a vertex may be routed to the primitive engine 335, which is configured to fetch vertex attributes associated with the vertex from the memory 204. In contrast, packets associated with a shader program may be transmitted to the SM 340.

The SM 340 comprises a programmable streaming processor that is configured to process tasks represented by a number of threads. Each SM 340 is multi-threaded and configured to execute a plurality of threads (e.g., 32 threads) from a particular group of threads concurrently. In an embodiment, the SM 340 implements a SIMD (Single-Instruction, Multiple-Data) architecture where each thread in a group of threads (i.e., a warp) is configured to process a different set of data based on the same set of instructions. All threads in the group of threads execute the same instructions. In another embodiment, the SM 340 implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The SM 340 will be described in more detail below in conjunction with FIG. 4A.

The MMU 390 provides an interface between the GPC 250 and the partition unit 280. The MMU 390 may provide translation of virtual addresses into physical addresses, memory protection, and arbitration of memory requests. In an embodiment, the MMU 390 provides one or more translation lookaside buffers (TLBs) for performing translation of virtual addresses into physical addresses in the memory 204.

FIG. 3B illustrates a memory partition unit 280 of the PPU 200 of FIG. 2, in accordance with an embodiment. As shown in FIG. 3B, the memory partition unit 280 includes a Raster Operations (ROP) unit 350, a level two (L2) cache 360, and a memory interface 370. The memory interface 370 is coupled to the memory 204. Memory interface 370 may implement 32, 64, 128, 1024-bit data buses, or the like, for high-speed data transfer. In an embodiment, the PPU 200 incorporates U memory interfaces 370, one memory interface 370 per pair of partition units 280, where each pair of partition units 280 is connected to a corresponding memory device 204. For example, PPU 200 may be connected to up to Y memory devices 204, such as high bandwidth memory stacks or graphics double-data-rate, version 5, synchronous dynamic random access memory, or other types of persistent storage.

In an embodiment, the memory interface 370 implements an HBM2 memory interface and Y equals half U. In an embodiment, the HBM2 memory stacks are located on the same physical package as the PPU 200, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 204 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 200 process very large datasets and/or run applications for extended periods.

In an embodiment, the PPU 200 implements a multi-level memory hierarchy. In an embodiment, the memory partition unit 280 supports a unified memory to provide a single unified virtual address space for CPU and PPU 200 memory, enabling data sharing between virtual memory systems. In an embodiment the frequency of accesses by a PPU 200 to memory located on other processors is traced to ensure that memory pages are moved to the physical memory of the PPU 200 that is accessing the pages more frequently. In an embodiment, the NVLink 210 supports address translation services allowing the PPU 200 to directly access a CPU's page tables and providing full access to CPU memory by the PPU 200.

In an embodiment, copy engines transfer data between multiple PPUs 200 or between PPUs 200 and CPUs. The copy engines can generate page faults for addresses that are not mapped into the page tables. The memory partition unit 280 can then service the page faults, mapping the addresses into the page table, after which the copy engine can perform the transfer. In a conventional system, memory is pinned (i.e., non-pageable) for multiple copy engine operations between multiple processors, substantially reducing the available memory. With hardware page faulting, addresses can be passed to the copy engines without worrying if the memory pages are resident, and the copy process is transparent.

Data from the memory 204 or other system memory may be fetched by the memory partition unit 280 and stored in the L2 cache 360, which is located on-chip and is shared between the various GPCs 250. As shown, each memory partition unit 280 includes a portion of the L2 cache 360 associated with a corresponding memory device 204. Lower level caches may then be implemented in various units within the GPCs 250. For example, each of the SMs 340 may implement a level one (L1) cache. The L1 cache is private memory that is dedicated to a particular SM 340. Data from the L2 cache 360 may be fetched and stored in each of the L1 caches for processing in the functional units of the SMs 340. The L2 cache 360 is coupled to the memory interface 370 and the XBar 270.

The ROP unit 350 performs graphics raster operations related to pixel color, such as color compression, pixel blending, and the like. The ROP unit 350 also implements depth testing in conjunction with the raster engine 325, receiving a depth for a sample location associated with a pixel fragment from the culling engine of the raster engine 325. The depth is tested against a corresponding depth in a depth buffer for a sample location associated with the fragment. If the fragment passes the depth test for the sample location, then the ROP unit 350 updates the depth buffer and transmits a result of the depth test to the raster engine 325. It will be appreciated that the number of partition units 280 may be different than the number of GPCs 250 and, therefore, each ROP unit 350 may be coupled to each of the GPCs 250. The ROP unit 350 tracks packets received from the different GPCs 250 and determines which GPC 250 that a result generated by the ROP unit 350 is routed to through the Xbar 270. Although the ROP unit 350 is included within the memory partition unit 280 in FIG. 3B, in other embodiment, the ROP unit 350 may be outside of the memory partition unit 280. For example, the ROP unit 350 may reside in the GPC 250 or another unit.

FIG. 4A illustrates the streaming multi-processor 340 of FIG. 3A, in accordance with an embodiment. As shown in FIG. 4A, the SM 340 includes an instruction cache 405, one or more scheduler units 410(K), a register file 420, one or more processing cores 450, one or more special function units (SFUs) 452, one or more load/store units (LSUs) 454, an interconnect network 480, a shared memory/L1 cache 470.

As described above, the work distribution unit 225 dispatches tasks for execution on the GPCs 250 of the PPU 200. The tasks are allocated to a particular DPC 320 within a GPC 250 and, if the task is associated with a shader program, the task may be allocated to an SM 340. The scheduler unit 410(K) receives the tasks from the work distribution unit 225 and manages instruction scheduling for one or more thread blocks assigned to the SM 340. The scheduler unit 410(K) schedules thread blocks for execution as warps of parallel threads, where each thread block is allocated at least one warp. In an embodiment, each warp executes 32 threads. The scheduler unit 410(K) may manage a plurality of different thread blocks, allocating the warps to the different thread blocks and then dispatching instructions from the plurality of different cooperative groups to the various functional units (i.e., cores 450, SFUs 452, and LSUs 454) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (i.e., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (i.e., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch unit 415 is configured to transmit instructions to one or more of the functional units. In the embodiment, the scheduler unit 410(K) includes two dispatch units 415 that enable two different instructions from the same warp to be dispatched during each clock cycle. In alternative embodiments, each scheduler unit 410(K) may include a single dispatch unit 415 or additional dispatch units 415.

Each SM 340 includes a register file 420 that provides a set of registers for the functional units of the SM 340. In an embodiment, the register file 420 is divided between each of the functional units such that each functional unit is allocated a dedicated portion of the register file 420. In another embodiment, the register file 420 is divided between the different warps being executed by the SM 340. The register file 420 provides temporary storage for operands connected to the data paths of the functional units.

Each SM 340 comprises L processing cores 450. In an embodiment, the SM 340 includes a large number (e.g., 128, etc.) of distinct processing cores 450. Each core 450 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the cores 450 include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the cores 450. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each SM 340 also comprises M SFUs 452 that perform special functions (e.g., attribute evaluation, reciprocal square root, and the like). In an embodiment, the SFUs 452 may include a tree traversal unit configured to traverse a hierarchical tree data structure. In an embodiment, the SFUs 452 may include texture unit configured to perform texture map filtering operations. In an embodiment, the texture units are configured to load texture maps (e.g., a 2D array of texels) from the memory 204 and sample the texture maps to produce sampled texture values for use in shader programs executed by the SM 340. In an embodiment, the texture maps are stored in the shared memory/L1 cache 370. The texture units implement texture operations such as filtering operations using mip-maps (i.e., texture maps of varying levels of detail). In an embodiment, each SM 240 includes two texture units.

Each SM 340 also comprises N LSUs 454 that implement load and store operations between the shared memory/L1 cache 470 and the register file 420. Each SM 340 includes an interconnect network 480 that connects each of the functional units to the register file 420 and the LSU 454 to the register file 420, shared memory/L1 cache 470. In an embodiment, the interconnect network 480 is a crossbar that can be configured to connect any of the functional units to any of the registers in the register file 420 and connect the LSUs 454 to the register file and memory locations in shared memory/L1 cache 470.

The shared memory/L1 cache 470 is an array of on-chip memory that allows for data storage and communication between the SM 340 and the primitive engine 335 and between threads in the SM 340. In an embodiment, the shared memory/L1 cache 470 comprises 128 KB of storage capacity and is in the path from the SM 340 to the partition unit 280. The shared memory/L1 cache 470 can be used to cache reads and writes. One or more of the shared memory/L1 cache 470, L2 cache 360, and memory 204 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 470 enables the shared memory/L1 cache 470 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 2, are bypassed, creating a much simpler programming model. In the general purpose parallel computation configuration, the work distribution unit 225 assigns and distributes blocks of threads directly to the DPCs 320. The threads in a block execute the same program, using a unique thread ID in the calculation to ensure each thread generates unique results, using the SM 340 to execute the program and perform calculations, shared memory/L1 cache 470 to communicate between threads, and the LSU 454 to read and write global memory through the shared memory/L1 cache 470 and the memory partition unit 280. When configured for general purpose parallel computation, the SM 340 can also write commands that the scheduler unit 220 can use to launch new work on the DPCs 320.

The PPU 200 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 200 is embodied on a single semiconductor substrate. In another embodiment, the PPU 200 is included in a system-on-a-chip (SoC) along with one or more other devices such as additional PPUs 200, the memory 204, a reduced instruction set computer (RISC) CPU, a memory management unit (MMU), a digital-to-analog converter (DAC), and the like.

In an embodiment, the PPU 200 may be included on a graphics card that includes one or more memory devices 204. The graphics card may be configured to interface with a PCIe slot on a motherboard of a desktop computer. In yet another embodiment, the PPU 200 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 4B is a conceptual diagram of a processing system 400 implemented using the PPU 200 of FIG. 2, in accordance with an embodiment. The exemplary system 465 may be configured to implement the method 100 shown in FIG. 1. The processing system 400 includes a CPU 430, switch 410, and multiple PPUs 200 each and respective memories 204. The NVLink 210 provides high-speed communication links between each of the PPUs 200. Although a particular number of NVLink 210 and interconnect 202 connections are illustrated in FIG. 4B, the number of connections to each PPU 200 and the CPU 430 may vary. The switch 410 interfaces between the interconnect 202 and the CPU 430. The PPUs 200, memories 204, and NVLinks 210 may be situated on a single semiconductor platform to form a parallel processing module 425. In an embodiment, the switch 410 supports two or more protocols to interface between various different connections and/or links.

In another embodiment (not shown), the NVLink 210 provides one or more high-speed communication links between each of the PPUs 200 and the CPU 430 and the switch 410 interfaces between the interconnect 202 and each of the PPUs 200. The PPUs 200, memories 204, and interconnect 202 may be situated on a single semiconductor platform to form a parallel processing module 425. In yet another embodiment (not shown), the interconnect 202 provides one or more communication links between each of the PPUs 200 and the CPU 430 and the switch 410 interfaces between each of the PPUs 200 using the NVLink 210 to provide one or more high-speed communication links between the PPUs 200. In another embodiment (not shown), the NVLink 210 provides one or more high-speed communication links between the PPUs 200 and the CPU 430 through the switch 410. In yet another embodiment (not shown), the interconnect 202 provides one or more communication links between each of the PPUs 200 directly. One or more of the NVLink 210 high-speed communication links may be implemented as a physical NVLink interconnect or either an on-chip or on-die interconnect using the same protocol as the NVLink 210.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 425 may be implemented as a circuit board substrate and each of the PPUs 200 and/or memories 204 may be packaged devices. In an embodiment, the CPU 430, switch 410, and the parallel processing module 425 are situated on a single semiconductor platform.

In an embodiment, the signaling rate of each NVLink 210 is 20 to 25 Gigabits/second and each PPU 200 includes six NVLink 210 interfaces (as shown in FIG. 4B, five NVLink 210 interfaces are included for each PPU 200). Each NVLink 210 provides a data transfer rate of 25 Gigabytes/second in each direction, with six links providing 300 Gigabytes/second. The NVLinks 210 can be used exclusively for PPU-to-PPU communication as shown in FIG. 4B, or some combination of PPU-to-PPU and PPU-to-CPU, when the CPU 430 also includes one or more NVLink 210 interfaces.

In an embodiment, the NVLink 210 allows direct load/store/atomic access from the CPU 430 to each PPU's 200 memory 204. In an embodiment, the NVLink 210 supports coherency operations, allowing data read from the memories 204 to be stored in the cache hierarchy of the CPU 430, reducing cache access latency for the CPU 430. In an embodiment, the NVLink 210 includes support for Address Translation Services (ATS), allowing the PPU 200 to directly access page tables within the CPU 430. One or more of the NVLinks 210 may also be configured to operate in a low-power mode.

FIG. 4C illustrates an exemplary system 465 in which the various architecture and/or functionality of the various previous embodiments may be implemented. The exemplary system 465 may be configured to implement the method 100 shown in FIG. 1.

As shown, a system 465 is provided including at least one central processing unit 430 that is connected to a communication bus 475. The communication bus 475 may be implemented using any suitable protocol, such as PCI (Peripheral Component Interconnect), PCI-Express, AGP (Accelerated Graphics Port), HyperTransport, or any other bus or point-to-point communication protocol(s). The system 465 also includes a main memory 440. Control logic (software) and data are stored in the main memory 440 which may take the form of random access memory (RAM).

The system 465 also includes input devices 460, the parallel processing system 425, and display devices 445, i.e. a conventional CRT (cathode ray tube), LCD (liquid crystal display), LED (light emitting diode), plasma display or the like. User input may be received from the input devices 460, e.g., keyboard, mouse, touchpad, microphone, and the like. Each of the foregoing modules and/or devices may even be situated on a single semiconductor platform to form the system 465. Alternately, the various modules may also be situated separately or in various combinations of semiconductor platforms per the desires of the user.

Further, the system 465 may be coupled to a network (e.g., a telecommunications network, local area network (LAN), wireless network, wide area network (WAN) such as the Internet, peer-to-peer network, cable network, or the like) through a network interface 435 for communication purposes.

The system 465 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 440 and/or the secondary storage. Such computer programs, when executed, enable the system 465 to perform various functions. The memory 440, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the system 465 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Machine Learning

Deep neural networks (DNNs) developed on processors, such as the PPU 200 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected perceptrons (e.g., nodes) that can be trained with enormous amounts of input data to quickly solve complex problems with high accuracy. In one example, a first layer of the DLL model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 200. Inferencing is less compute-intensive than training, being a latency-sensitive process where a trained neural network is applied to new inputs it has not seen before to classify images, translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 200 is a computing platform capable of delivering performance required for deep neural network-based artificial intelligence and machine learning applications.

### Exemplary Semantic Segmentation Environment

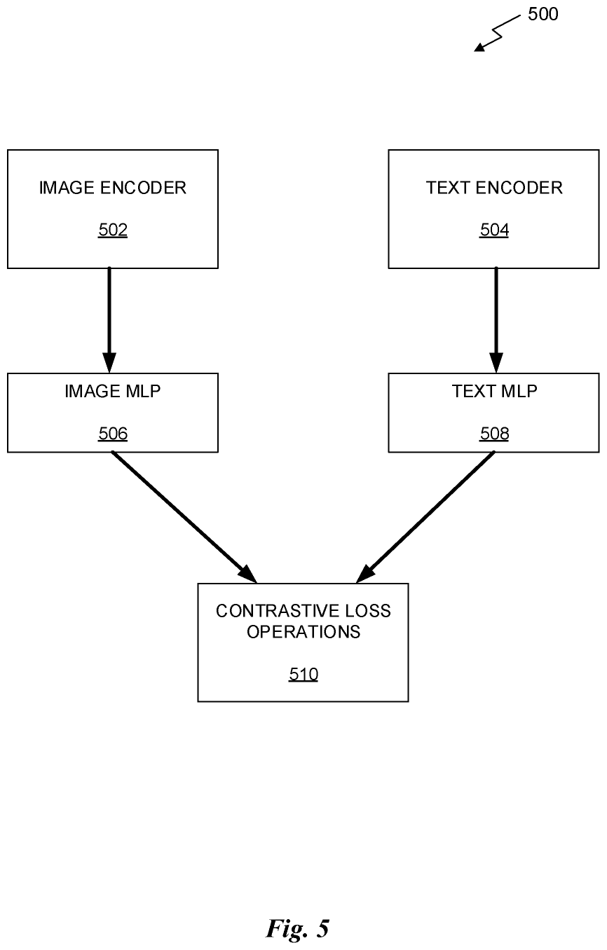

FIG. 5 illustrates an exemplary machine learning environment 500 for performing semantic segmentation, according to one exemplary embodiment. As shown, the machine learning environment 500 includes an image encoder 502 and a text encoder 504. In one embodiment, during the training of the machine learning environment 500, for each of a plurality of image/caption pairs, the image may be extracted and input into the image encoder 502. The image encoder 502 may then output potential pixel groupings for each image.

Additionally, during the training of the machine learning environment 500, for each of a plurality of image/caption pairs, nouns from each of the captions along with the captions themselves may be extracted by the machine learning environment 500, and each extracted noun may be converted to a text prompt by the machine learning environment 500. These text prompts and caption may be input into the text encoder 504, and the text encoder 504 may output a text representation of each input text prompt for each extracted noun or caption.

Further, during the training of the machine learning environment 500, for each of the plurality of image/caption pairs, the potential pixel groupings determined for the image that were output by the image encoder 502 may be converted to extracted features for the image utilizing an image multilayer perceptron (MLP) 506. Also during the training of the machine learning environment 500, for each of the plurality of image/caption pairs, the text representation of each input text prompt for each extracted noun determined for the caption and the caption itself may be converted to extracted features for nouns of the caption and for the caption utilizing a text MLP 508.

Further still, during the training of the machine learning environment 500, contrastive loss operations 510 implemented by the machine learning environment 500 may create a similarity matrix, utilizing the extracted features for each image and the extracted features for the nouns of the caption and the caption itself. The contrastive loss operations 510 may also create similarity matrices for each image and extracted features for nouns of and other non-matching captions. The contrastive loss operations 510 may then compare similarity matrices to determine an extracted feature for a noun of the caption that most closely matches the extracted features for the various groups of the image. In this way, for each potential pixel grouping within the image, the contrastive loss operations 510 of the machine learning environment 500 may be trained to identify a noun from the caption that most closely matches the grouping.

After the machine learning environment 500 has been trained, an unlabeled image may be provided as input into the trained machine learning environment 500. The image encoder 502 of the trained machine learning environment 500 may output potential pixel groupings within the unlabeled image. A list of user-provided category names may also be input into the trained machine learning environment 500, where the trained machine learning environment 500 may convert each category name into a text prompt and the text encoder 504 may output a text representation of each input text prompt for each category name.

Also, the potential pixel groupings determined for the unlabeled image may be converted to extracted features for the unlabeled image by the image MLP 506, and the text representation of each input text prompt for each category name may be converted to extracted features for the category name by the text MLP 508. The trained machine learning environment 500 may perform vision-textual similarity computation operations 510 to create a similarity matrix, utilizing the extracted features for the unlabeled image and the extracted features for the category names. For each of the extracted features for the unlabeled image, the vision-textual similarity computation operation may determine and return an extracted features for category names that most closely match the extracted grouping features for the unlabeled image.

In this way, the machine learning environment 500 may be trained utilizing generic and widely available image/caption pairs (as opposed to manually annotated semantic segmentation map training images).

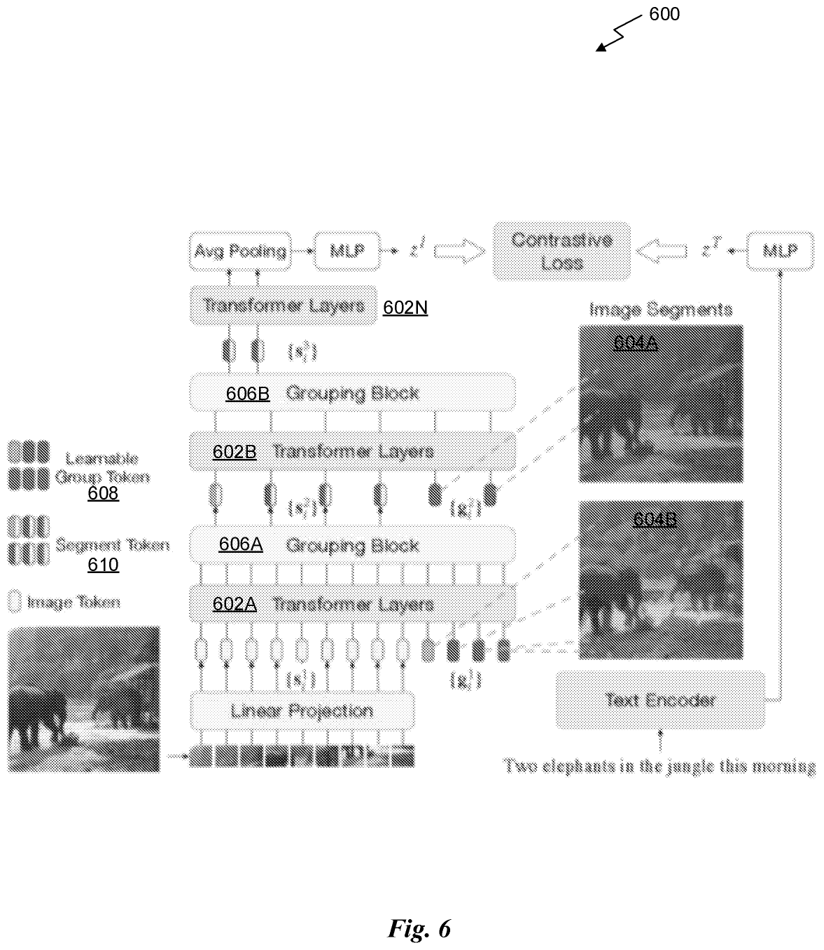

FIG. 6 illustrates an exemplary GroupViT Architecture and Training Pipeline 600 for performing semantic segmentation, according to one exemplary embodiment. As shown, the GroupViT 600 includes a hierarchy of transformer layers 602A-N grouped into stages, each operating on progressively larger visual segments. The images on the right 604A-B show visual segments that emerge in the different grouping stages. A lower stage groups pixels into object parts, e.g., noses and legs of elephants; and the higher stage further merges them into entire objects, e.g., the whole elephant and the background forest. Each grouping stage ends with a grouping block 606A-B that computes the similarity between the learned group tokens 608 and segment (image) tokens 610. The assignment may be computed via gumbel softmax over group tokens and converted into a one-hot hard assignment. The segment tokens 610 assigned to the same group may be merged together and represent new segment tokens that are input to the next grouping stage.

Zero-Shot Transfer to Semantic Segmentation with Text Supervision

Visual scenes are naturally composed of semantically-related groups of pixels. In bottom-up grouping, the idea is to first re-organize pixels into candidate groups and then to process each group with a recognition module. This pipeline has been successfully applied in image segmentation from superpixels, constructing region proposals for object detection and semantic segmentation. Beyond bottom-up inference, top-down feedback from recognition can also provide signals to perform better visual grouping. However, on moving to the deep learning era, the ideas of explicit grouping and recognition have been much less separated and more tightly coupled in end-to-end training systems. Semantic segmentation may be achieved via a Fully Convolutional Network, where pixel grouping is only revealed at the output by recognizing each pixel's label. This approach eliminates the need to perform explicit grouping. This method has two major limitations: (1) learning is limited by the high cost of per-pixel human labels; and (2) the learned model is restricted only to a few labeled categories and cannot generalize to unseen ones.

In one embodiment, a semantic segmentation model may be trained purely with text supervision and without any per-pixel annotations capable of generalizing to different sets of objects categories, or vocabularies, in a zero-shot manner. To accomplish this, a grouping mechanism may be incorporated into deep networks, which allows semantic segments to emerge automatically with only text supervision.

By training on large-scale paired image-text data with contrastive losses, the model may be zero-shot transferred to several semantic segmentation vocabularies, without requiring any further annotation or fine-tuning. A vision transformer (ViT) may be used, and a new visual grouping module may be incorporated into it.

Compared to convolutional neural networks, which operate on regular grids, the global self-attention mechanism of Transformers naturally provides the flexibility to combine visual tokens into non-grid-like segments. Thus, instead of organizing visual tokens into grids, hierarchical grouping of visual tokens into irregular-shaped segments may be performed. Specifically, a model may be organized in different stages through a hierarchy of transformer layers, where each stage contains multiple transformers to perform information propagation among the group segments, and a grouping module that merges smaller segments into larger ones. With different input images, the model may dynamically form different visual segments, each intuitively representing a semantic concept.

Training of the machine learning environment may be performed using text supervision only. To perform training, visual segment outputs may be merged in the final stage of the machine learning environment using average pooling. This image-level embedding may then be compared to those derived from textual sentences via contrastive learning. Positive training pairs may be constructed by using corresponding image and text pairs, and negative ones by using text from other images. The text embedding may be extracted with a transformer model, trained jointly along with the machine learning environment from scratch.

During inference for the task of semantic segmentation, given an input image, the trained machine learning environment extracts visual groups. Each final group's output represents a segment of the image. Given a vocabulary of label names for segmentation, the machine learning environment uses the text transformer to extract each label's textual embedding. To perform semantic segmentation, the machine learning environment assigns the segmentation labels to image segments according to their mutual similarity in the embedding space.

In summary, moving beyond regular-shaped image grids in deep networks, the machine learning environment architecture performs hierarchical bottom-up grouping of visual concepts into irregular-shaped groups. Without any pixel-wise labels and training with only image-level text supervision via contrastive losses, the machine learning environment successfully learns to group image regions together and transfers to several semantic segmentation vocabularies in a zero-shot manner. This enables a zero-shot transfer from text supervision alone to several semantic segmentation tasks without using any pixel-wise labels.

Exemplary Method

A machine learning environment architecture is provided for zero-shot transfer to semantic segmentation with text supervision only. This machine learning environment introduces a new hierarchical grouping transformer architecture that exploits the global self-attention mechanism of transformers to partition input images into progressively larger arbitrary-shaped groups.

Grouping Vision Transformer

The machine learning environment architecture image encoder performs hierarchical progressive grouping of visual concepts via a transformer-based architecture. In the machine learning environment architecture, transformer layers are separated into multiple grouping stages. In each stage, a number of group tokens are learned (as learnable parameters) via self-attention that aggregate information globally from all image tokens (segments). The learned group tokens are used to merge similar image tokens together via a grouping block. Through a hierarchy of grouping stages, smaller image segments are grouped into larger ones.

Architecture

An input image is split into N non-overlapping patches and each is linearly projected into a latent space. Each projected patch is treated as an input image token and the set of all tokens is denoted as {pᵢ}ᵢ₌₁^{N}. In each grouping stage, besides the image tokens, a set of learnable group tokens is concatenated input into the transformer for that stage.

Multi-Stage Grouping

Instead of forwarding all the N input image tokens through all the layers of the transformer, its layers are separated into a hierarchy of grouping stages. Each stage incorporates a grouping block at its end to merge the smaller groups into larger ones. Formally, suppose there are L grouping stages, each indexed by 1 and with a set of learnable group tokens {gᵢ}ᵢ₌₁^{M}^{₁}.

For simplicity, the image patches {pᵢ}ᵢ₋₁^{N} input to the first grouping stage are treated as the set of starting segments {sᵢ¹}ᵢ₌₁^{M}^{ₒ}, where N=M₀. {sᵢ^{l}}ᵢ₌₁^{M}^{ₜ₋₁} is simplified to {sᵢ^{l}} and similarly {gᵢ^{l}}ᵢ₋₁^{M}^{₁} is simplified to {gᵢ^{l}}. Starting with l=1, for each grouping stage, {sᵢ^{l}} and {gᵢ^{l}} are concatenated together and then input them into a number of transformer layers, each of which performs information propagation between them via

{ĝᵢ^{l}},{ŝᵢ^{l}},Transformer([{gᵢ^{l}};{sᵢ^{l}}]),

where [;] denotes the concatenation operator. Then the updated Mₗ₋₁ image segment tokens {ŝᵢ^{l}} are grouped into Mₗ new segment tokens {sᵢ^{l+1}}ⁱ⁼¹ via a grouping block as

{sᵢ^{l+1}}=GroupingBlock({ĝᵢ^{l}},{ŝᵢ^{l}}),

In each grouping stage Mₗ<Mₗ₋₁, i.e., there are progressively fewer group tokens, resulting in progressively larger and fewer image segments. After the final grouping stage, L, Transformer layers are applied on all segment tokens and their outputs are averaged to obtain the final global image representation z^{I} as

{sᵢ^{L+1}}Transformer({sᵢ^{L+1}}), (1)

z¹=MLP(AvgPool({sᵢ^{L+1}})). (2)

The machine learning environment re-organizes visual information into arbitrary image segments after the first stage itself and thus is not confined to a regular-grid structure.

Grouping Block

The Grouping Block at the end of each grouping stage takes the learned group tokens and image segment tokens as inputs. It merges all the segment tokens that are assigned to the same group token into a single new image segment, based on similarity in the embedding space.

Formally, the similarity matrix A¹ is computed between the group tokens {ĝᵢ^{l}} and segment tokens {ŝᵢ^{l}} via a Gumbel-Softmax operation computed over the group tokens as

$${A}_{i , j}^{l} = \frac{exp ( {W}_{q} {\hat{g}}_{i}^{l} \cdot {W}_{k} {\hat{s}}_{j}^{l} + {γ}_{i} )}{{\sum }_{k = 1}^{{M}_{l}} exp ( {W}_{q} {\hat{g}}_{k}^{l} \cdot {W}_{k} {\hat{s}}_{j}^{l} + {γ}_{k} )} , \qquad ( 3 )$$

where W_{q} and Wₖ are the weights of the learned linear projections for the group and segment tokens, respectively, and {γᵢ} are i.i.d random samples drawn from the Gumbel(0, 1) distribution. The group is computed to assign a segment token to by taking the one-hot operation of its argmax over all the groups. Since the one-hot assignment operation via argmax is not differentiable, a straight through trick is used to compute the assignment matrix as

Â^{l} one-hot(A_{arqmax}^{l})+A^{l}−sg(A^{l}), (4)

where sg is the stop gradient operator. With the straight through trick, Â^{l} has the one-hot value of assignment to a single group, but its gradient is equal to the gradient of A^{l}, which makes the grouping block differentiable and end-to-end trainable. This one-hot assignment strategy is called a hard assignment. An alternative to hard assignment is soft assignment, which uses A^{l} instead of Â^{l} for computing equation 5.

After assigning the segment tokens to the different learned groups, the embeddings of all the tokens belonging to the same group are merged to form a new segment token sᵢ^{l+1}.

For each group, the output of the grouping block is a weighted sum of the segment tokens assigned to that group and computed as

$${s}_{i}^{l + 1} = {\hat{g}}_{i}^{l} + {W}_{o} \frac{{\sum }_{j = 1}^{{M}_{l - 1}} {\hat{A}}_{i , j}^{l} {W}_{v} {\hat{s}}_{j}^{l}}{{\sum }_{j = 1}^{{M}_{l - 1}} {\hat{A}}_{i , j}^{l}} , \qquad ( 5 )$$

where Wᵥ and Wₒ are the learned weights to project the merged features.

Learning from Image-Text Pairs

To train the machine learning environment to perform hierarchical grouping, contrastive losses between image-text pairs may be used.

Image-Text Contrastive Loss

To learn visual representations via text supervision, a dual-encoder architecture is trained via an image-text contrastive loss. The machine learning environment acts as the image encoder and a transformer acts as the text encoder. The final image embedding from the machine learning environment (equation 2) is the average embedding of all its output segment tokens. The text embedding is the embedding of the last output token (end-of-sentence token) from the text transformer. The input image and text are forwarded as a pair through their respective encoders and are projected into a common embedding space, where a similarity measure is computed between them. All matched image-text pairs are considered as positive pairs, and all other unmatched ones are considered as negative pairs. The training objective may include pulling the representations of the positive pairs closer to each other, while pushing those of the unmatched ones far away from each other via a contrastive loss.

Formally, assume a batch of B image-text pairs {(xᵢ^{I},xᵢ^{T})}ᵢ₌₁^{B}, where xᵢ^{I} and xᵢ^{T} are the image and text inputs, respectively, of the i-th pair. Each of them are encoded via their respective encoders into embedding vectors [symbol] ᵢ^{I} and [symbol] ᵢ^{T} and are l2-normalized. Their similarity is then measured by computing their dot product. The total image-text contrastive loss is defined as

[symbol]

_{I↔T}= [symbol] _{I→T}+ [symbol] _{T→I}, (6)

which is composed of an image-to-text contrastive loss defined as

$${ℒ}_{I \to T} = - \frac{1}{B} {\sum }_{i = 1}^{B} log \frac{exp ( {z}_{i}^{I} \cdot {z}_{i}^{T} / τ )}{{\sum }_{j = 1}^{B} exp ( {z}_{i}^{I} \cdot {z}_{j}^{T} / τ )} ,$$

and a text-to-image contrastive loss defined as

$${ℒ}_{T \to I} = - \frac{1}{B} {\sum }_{i = 1}^{B} log \frac{exp ( {z}_{i}^{T} \cdot {z}_{i}^{I} / τ )}{{\sum }_{j = 1}^{B} exp ( {z}_{i}^{T} \cdot {z}_{j}^{I} / τ )} ,$$

where [symbol] is a learnable temperature parameter to scale the logits.

Multi-Label Image-Text Contrastive Loss

To enable effective visual grouping, besides the image-text loss in equation 6, a multi-label contrastive loss with text prompting is used. A “prompting engineering” mechanism may be used to generate additional text labels for each image besides its originally provided sentence caption. Specifically, K noun words may be randomly selected from a sentence caption xᵢ^{T}, and each word is prompted with a set of handcrafted sentence templates (e.g., “A photo of a {noun}”).

Nouns may be selected since objects in images are more likely to be described by these nouns. Besides training with the original image-caption pairs {(xᵢ^{I}, xᵢ^{T})}ᵢ₌₁^{B}, additional contrastive losses between the new sets of image-“prompted text” pairs

{(xᵢ^{I},xᵢ^{T}^{₁})}ᵢ₌₁^{B},{(xᵢ^{I},xᵢ^{T}^{₂})}ᵢ₌₁^{B}, . . . ,{(xᵢ^{I},xᵢ^{T}^{_{K}})}ᵢ₌₁^{P}

may be employed, where {xᵢ^{T}^{ₖ}}ₖ₌₁^{K} are all prompted sentences generated from the nouns sampled from the sentence caption xⁱ_{T}.

Compared to the standard contrastive loss (equation 6), which results in only one positive pair among the batch B, in the present case, each image xᵢ^{I} has K positive text pairs and B(K−1) negative ones.

Similar to the standard image-text contrastive loss (equation 6), the multi-label contrastive loss is defined as

$${ℒ}_{I ↔ {\{ {T}_{k} \}}_{k = 1}^{K}} = {ℒ}_{I \to {\{ {T}_{k} \}}_{k = 1}^{K}} + {ℒ}_{{\{ {T}_{k} \}}_{k = 1}^{K} \to I} , \qquad ( 7 )$$

which is a sum of two two-way contrastive losses

$${ℒ}_{I \to {\{ {T}_{k} \}}_{k = 1}^{K}} = - \frac{1}{B} {{\sum }_{i = 1}}^{B} log \frac{{\sum }_{k = 1}^{K} exp ( {z}_{i}^{I} \cdot {z}_{i}^{{T}_{k}} / τ )}{{\sum }_{k = 1}^{K} {\sum }_{j = 1}^{B} exp ( {z}_{i}^{I} \cdot {z}_{j}^{{T}_{k}} / τ )} and$$

$${ℒ}_{{\{ {T}_{k} \}}_{k = 1}^{K} \to I} = - \frac{1}{KB} {\sum }_{k = 1}^{K} {\sum }_{i = 1}^{B} log \frac{exp ( {z}_{i}^{{T}_{k}} \cdot {z}_{i}^{I} / τ )}{{\sum }_{j = 1}^{B} exp ( {z}_{i}^{{T}_{k}} \cdot {z}_{j}^{I} / τ )} .$$

Finally, the total image-text contrastive loss for training the machine learning environment is defined as

$$ℒ = {ℒ}_{I ↔ T} + {ℒ}_{I ↔ {\{ {T}_{k} \}}_{k = 1}^{K} .} \qquad ( 8 )$$

Zero-Shot Transfer to Semantic Segmentation

As the machine learning environment automatically groups images into semantically-similar segments, its output can be easily zero-shot transferred to semantic segmentation without any further fine-tuning.

To infer the segments of an image belonging to a finite vocabulary of object classes, a test image is forwarded through the machine learning environment without applying AvgPool to its final L output segments, and to obtain the embedding of each of them as { [symbol] ᵢ^{I}}ᵢ₌₁^{M}^{_{L}}.

Each segment token corresponds to an arbitrarily-shaped region of the input image. The similarity is then computed between the embedding of each segment token and the text embedding of all the semantic classes present in the dataset. Each image segment is assigned to the semantic class with the highest image-text embedding similarity.

Specifically, let Â^{l} be the assignment matrix of the l-th grouping stage, which indicates the mapping between the input and output segments of l-th stage. Multiplying all the stage-level assignment matrices Π_{i=L}¹ Â^{l} yields the final assignment between the input patches {pⁱ}ᵢ₌₁^{N} land the final-stage output tokens { [symbol] ᵢ^{I}}ᵢ₌₁^{M}^{_{L}}.

The same “prompting engineering” as described above is used to transform all the semantic segmentation label names into sentences. The embedding of label names in the dataset is { [symbol] ᵢ^{T}}ᵢ₌₁^{C} where zᵢ^{I} is the number of classes. To classify the spatial region of the image corresponding to the segment [symbol] ᵢ^{I}, the dot product between l₂-normalized class name embedding vectors { [symbol] ᵢ^{T}}ᵢ₌₁^{C} and [symbol] ᵢ^{I} is computed and the class with the highest similarity is predicted.

In this way, learning semantic segmentation machine learning may be trained with text alone and without any explicit human supervision. The representation learned from large-scale noisy image-text pairs can be transferred to semantic segmentation in a zero-shot manner. Besides image classification, text supervision may also be transferred to finer-grained vision tasks.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising, at a device:
training a machine learning environment, utilizing a plurality of image/caption pairs; and
performing semantic segmentation, utilizing the trained machine learning environment.

2. The method of claim 1, wherein the machine learning environment is trained to perform the semantic segmentation.

3. The method of claim 1, wherein the plurality of image/caption pairs used to train the machine learning environment are retrieved from one or more image databases.

4. The method of claim 1, wherein the machine learning environment includes an image encoder, where for each of the plurality of image/caption pairs, the image is extracted and input into the image encoder.

5. The method of claim 4, wherein for each input image, the image encoder outputs potential pixel groupings of pixels within the image.

6. The method of claim 1, wherein the machine learning environment includes a text encoder, and for each of the plurality of image/caption pairs:
one or more nouns are extracted from the caption,
each extracted noun is converted to a text prompt, and
each text prompt and the original caption is input into the text encoder.

7. The method of claim 6, wherein the text encoder outputs a text representation of each input text prompt for each extracted noun and for the original caption.

8. The method of claim 1, wherein the machine learning environment performs one or more contrastive loss operations during training.

9. The method of claim 1, wherein an unlabeled image and a list of user-provided category names are input into the trained machine learning environment.

10. The method of claim 1, wherein the trained machine learning environment performs one or more vision-text similarity computation operations during inference.

11. A system comprising:
a hardware processor of a device that is configured to:
train a machine learning environment, utilizing a plurality of image/caption pairs; and
perform semantic segmentation, utilizing the trained machine learning environment.

12. The system of claim 11, wherein the machine learning environment is trained to perform the semantic segmentation.

13. The system of claim 11, wherein the plurality of image/caption pairs used to train the machine learning environment are retrieved from one or more image databases.

14. The system of claim 11, wherein the machine learning environment includes an image encoder, where for each of the plurality of image/caption pairs, the image is extracted and input into the image encoder.

15. The system of claim 14, wherein for each input image, the image encoder outputs potential pixel groupings of pixels within the image.

16. The system of claim 11, wherein the machine learning environment includes a text encoder, and for each of the plurality of image/caption pairs:
one or more nouns are extracted from the caption,
each extracted noun is converted to a text prompt, and
each text prompt and the original caption is input into the text encoder.

17. The system of claim 16, wherein the text encoder outputs a text representation of each input text prompt for each extracted noun and for the original caption.

18. The system of claim 11, wherein the machine learning environment performs one or more contrastive loss operations during training.

19. A non-transitory computer-readable storage medium storing instructions that, when executed by a processor of a device, causes the processor to cause the device to:
train a machine learning environment, utilizing a plurality of image/caption pairs; and
perform semantic segmentation, utilizing the trained machine learning environment.

20. The computer-readable storage medium of claim 19, wherein the machine learning environment performs one or more contrastive loss operations during training.
